(19) United States
(12) Patent Application Publication
(10) Pub. No.: US 2018/0117819 A1
(43) Pub. Date: May 3, 2018

(54) INHERENTLY SUPER-OMNIPHOBIC FILAMENTS, FIBERS, AND FABRICS AND SYSTEM FOR MANUFACTURE

(71) Applicants: Clemson University Research Foundation, Clemson, SC (US); The United States Department of Defense Department of the Army, Washington, DC (US)

(72) Inventors: Philip Brown, Anderson, SC (US); Quoc Tien Truong, Hyde Park, MA (US); Nicole Hoffman, Ashland, MA (US)

(73) Assignees: Clemson University Research Foundation, Clemson, SC (US); The United States Department of Defense Department of the Army, Washington, DC (US)

(21) Appl. No.: 15/795,660

(22) Filed: Oct. 27, 2017

Related U.S. Application Data
(60) Provisional application No. 62/413,514, filed on Oct. 27, 2016.

(51) Int. Cl. B29C 47/00; D01D 4/02; D03D 15/00

(52) U.S. Cl. CPC B29C 47/0014; B29K 2995/0093; D03D 15/00; D01D 4/02

(57) ABSTRACT

Invention is directed to a method of extruding an omni-phobic filament comprising: extruding a co-polymer filament having a first polymer at a core having generally a circular cross-section, and a second polymer disposed at a perimeter of the core wherein the second polymer is dissolvable; creating channels disposed at the perimeter of the core by dissolving the second polymer; creating trapezoidal cross-section features having a distal angle less than 70°, a top edge greater than a side length and a bottom length less than the side length; and adding nano-sized particles to at least one of the top edge and one or more sides or any combination thereof.

### CLAIM OF PRIORITY

The application claims priority on U.S. 62/413,514 filed Oct. 27, 2017.

### STATEMENT REGARDING FEDERALLY SPONSORED RESEARCH

This invention was made with government support under Grant No. W911QY-14-P-0413 awarded by the Department of Defense, United States Department of the Army. The government has certain rights in the invention.

### BACKGROUND OF THE INVENTION

### 1. Field of the Invention

This invention is a manufacturing process and resulting article of manufacture, filaments, fiber, and fabrics, with modified surface geometries having a plurality of reentrant features to provide filaments, fiber, and fabrics with super-omniphobic physical properties.

### 2. Description of Related Art

In the field of fabrics, there is much work to be done to improve the longevity and utility of fabrics such as those used for uniforms, outdoor wear, and the like. For example, the military has a need for soldier's uniforms that resist water, oil, and other liquids. Typically, the soldier, and other individuals in a variety of environments, encounter muddy terrains, dusty battlefields, and oil-contaminated environments. The benefits of reduced wear and improve functionality can be achieved with clean uniforms. Therefore, it is desirable to remove or prevent dirt and/or contaminants from affixing to the surface of clothing's textile materials. Further, the functionality of efficacy of enzymatic, surface active, and/or oil-dissolving detergents can be enhanced with textiles that resist liquids and solids. Other uses can include material for sports gear, rain gear, pants, jackets, seats, umbrellas, or any application where there is need for the material to be repellent.

Previous attempts to provide an omniphobic material were limited to coatings that were applied to the surface of materials such as perfluorooctanoic acid (PFOA). However, PFOA has a significant disadvantage as it includes a C8 chemistry and has been found to be environmentally toxic with major negative biological effects on humans due to bioaccumulation. PFOA has been classified as a “likely human carcinogen” and the use of this chemical was heavily restricted. The use of C8 chemistry was banned from consumer products and manufacturing emissions around 2015. Further, a major drawback to relying on coatings for the hydrophobic properties on textiles is that they do not hold up to laundering and the properties decline after washing.

Attempts have been made to develop capillary-channeled polymer fibers modified for defense against chemical and biological contaminants such as shown in United States Patent Application Publication 2011/0003144. This reference is directed to a method of preparing a fiber or an article suitable for use in defending against a biological or a chemical contaminant, and the resulting fiber or article. However, this reference is directed to a non-circular cross section. Another such attempt is shown in United States Patent Application Publication 2014/0187666 directed to a self-healing, scratch resistant slippery surface that is manufactured by wicking a chemically-inert, high-density liquid coating over a roughened solid surface featuring micro and nanoscale topographies. However, this reference seems to be directed to using a lubricating fluid layer. The article has a solid substrate on which the lubricating fluid adheres.

U.S. Pat. No. 7,985,475 is directed to nanofibers and nanofiber structures comprising exogenous hydrophobic, lipophobic, or amphiphobic material and which display super-hydrophobic, super-lipophobic, and/or super-amphiphobic properties. This reference is directed to a coating and specifically to a plurality of nanofibers grown on said first surface, the nanofibers comprising a non-carbon material and having an exposed external surface and a first end which is attached to the first surface and a second, free end which is unattached to the first surface and extends from the first surface, which plurality of nanofibers comprises a coating of one or more exogenous liquidphobic material deposited on the exposed external surface of the nanofibers which coating extends over the length of the nanofibers from the first end to the second end thereof.

U.S. Pat. No. 9,315,939 is directed to a monofilament with longitudinally oriented grooves and fabrics made thereof having reduced air permeability, wherein the reduced permeability is achieved without using additional coatings or stuffer yarns. Bicomponent monofilaments made from these grooved monofilaments using solution or wire coating have improved coating adhesion and may also include a conductive coating. The grooved monofilaments exhibit improved adhesion to “sheet-grip” coatings, as compared with circular monofilaments.

U.S. Pat. No. 6,790,796 is directed to striated yarns for providing enhanced roughness and texture. The striated yarns include parallel grooves or channels that run lengthwise along the surface of the monofilament yarn. The channels are of semicircular cross-sectional shape, although the shape of the channels may be of any other shape without departing from the scope of the present invention. Preferably, the depth of the channels is from 5% to 25% of the diameter of the monofilament yarn. The monofilament yarn may have the circular cross section, but may alternatively be of oval, or elliptical, square or rectangular cross-sectional shape.

While some attempts have been made to provide the benefits of the present invention, none have provided an adequate filament, fiber or fabric with reentrant features to provide for super-omniphobic physical properties.

Therefore it is an object of the present invention to provide a manufacturing process and resulting article of a filament, fiber or fabric with reentrant features based upon dual hierarchical micro/nano-scale surface features or structures.

It is another object of the present invention to provide a manufacturing process and resulting article of a filament, fiber, or fabric with increased liquid repellencies.

It is another object of the present invention to provide a manufacturing process and resulting article of a filament, fiber or fabrics with necessarily using chemical modifications to the filament, fiber or fabric.

### BRIEF SUMMARY OF THE INVENTION

The above objectives are achieved by providing a method of extruding an omni-phobic filament comprising: extruding a co-polymer filament having a first polymer at a core having generally a circular cross-section and a second polymer disposed at a perimeter of the core wherein the second polymer is dissolvable; creating channels disposed at the perimeter of the core by dissolving the second polymer; creating trapezoidal cross-section features having a distal angle less than 70°, a top edge greater than a side length and a bottom length less than the side length; and, adding nano-sized particles to at least one of the top edge and one or more sides or any combination thereof.

The invention can include creating a fiber having multiple filaments. The invention can include creating a fabric having multiple fibers. The step of creating trapezoidal cross-section features can include creating trapezoidal cross-section features having a peak to peak length between adjoining trapezoidal cross-section features is less than 30 μm. The number of trapezoidal cross-section features can be in the range of 8 to 64 and can be 16. The trapezoidal cross-section feature can have a height in the range of 5 μm to 30 μm. The invention can include a ratio of a core diameter to a trapezoidal cross-section feature heights in the range of 90:10 to 60:40. It can be 70:30.

The invention can use an extrusion method that includes a 19 filament/opening spinneret, extrusion temperature of up to 450° C., godet speed between 200 and 2000 m/sec and winder speed of between 500-2500 m/min. The co-polymer can have generally a circular cross section. The core can have a general gear appearance cross section. Nano-sized particles can be added using pressure impregnation, post-extrusion bath, post-extrusion, deposit, post-extrusion coating, or any combination thereof. Fibers resulting from extrusion can be single or bicomponent.

The first polymer can be is a polypropylene, nylon and/or others, and the second polymer can be a soluble polymer. In one embodiment, the second polymer can be a water soluable polymer such as melt extrudable PVOH types exemplified by Nichigo G-polymer. The method of manufacturer can include providing a polymer feedstock; providing an extruded configured to extrude co-polymer filament each having a first polymer at a core having generally a circular cross-section and a second polymer disposed at a perimeter of the core wherein the second polymer is dissolvable; creating channels disposed at the perimeter of the core by dissolving the second polymer post extrusion; creating trapezoidal cross-section features having a distal angle less than 63°; and, combining the filaments having trapezoidal cross-section features into a fiber. Nano-sized particles can be added to at least one of the top edge and one or more sides or any combination thereof of one or more trapezoidal cross-section features. The filaments or fibers can be drawn. When drawn or spun at higher speeds it is evident that the core of the filaments can be in the range of 10 μm, 15 μm, 30 μm, and 75 μm and the trapezoidal cross-sectional features modified therein.

The core diameter can be in the typical range of 10 μm and 75 μm; and, there can be between 7 and 25 trapezoidal cross-section features disposed along the perimeter of the core wherein a majority of the trapezoidal cross section features have a geometric angle of less than about 65°. There can be between 7 and 25 trapezoidal cross-section features and a core having an inner perimeter; wherein nano-sized particles can be added using pressure impregnation, post-extrusion bath, post-extrusion deposit, post-extrusion coating, or any combination thereof to the top, sides, inner perimeter, or any combination thereof.

The filament and fiber that is extruded can have a core comprising a raw material that can include PP, Nylon, PET, and any melt spinnable polymer. The manufacturing process allows the following variable to be controlled to effect the fiber's ultimate performance and/or physical properties and can include (a) melt temperature, (b) draw rate, and (c) pack plate configuration. The fiber can be an extruded bi-component with a core and second dissolvable component extruded into round fibers. When the dissolvable portion is dissolved, the fiber has channels lengthwise around the perimeter. In one embossment, it is a gear cross section. The ratio of core diameter to feature height can be in the range of 90:10 to 60:40. In one embodiment, the range is 80:20 to 70:30.

### BRIEF DESCRIPTION OF THE SEVERAL VIEWS OF THE DRAWINGS

The invention and its advantages will appear in the description and claims, and with reference to the accompanying drawings forming a part of the disclosure wherein like reference characters designate corresponding parts in the several views.

FIG. 1 is perspective view with a front view cutout of aspects of the invention;

FIG. 2 is a schematic of aspects of the present invention;

FIG. 3 is a graph representing physical properties of the invention;

FIG. 4 is a perspective view of aspects of the invention;

FIGS. 5A through 5D are magnified views of aspects of the invention;

FIGS. 6A through 6D are magnified views of aspects of the invention;

FIGS. 7A through 7B are magnified views of cross sections of aspects of the invention;

FIG. 8 is a schematic of the apparatus and aspects of the present invention;

FIGS. 9A and 9B are views of aspects and components of the invention;

FIG. 10 is a magnified view of a cross sections of aspects of the invention;

FIGS. 11A and 11B are cross section and perspective views of aspects of the invention; and,

FIG. 12 is an image of cross section of aspects of the invention.

### DETAILED DESCRIPTION OF THE INVENTION

This invention is directed to a filament, fiber and fabric that can be hydrophobic and oleophobic so that the manufacturing methods produce a omniphobic filament, fiber, or fabric. The features that the resulting filament, fiber and fabric can have are surface chemistry, surface micro-roughness, nano-roughness, and micro- or nano-reentrant features. In a fabric, the physical properties can be influenced by the weave structural openings, weave pattern, physical properties of the individual fiber, and the physical properties of the individual filaments.

In manufacturing the materials of the present invention, bicomponent modification in the melt spinning process can be modified to change the cross sectional geometry of the fiber in order to create trapezoidal air pockets along the perimeter of the fibers providing reentrant features. In one embodiment, a water soluble polymer can be used as the sheath and can be removed after fiber production. A bicomponent fiber spinneret can be used to produce fibers with reentrant features in the range of 8 to 16. In one embodiment, 18 melt flow index (MFI) polypropylene and Nylon 6 can be used as polymer cores. In one circumstance, Nylon 6 provides a more favorable cross sectional shape geometry.

The mechanical properties of the fibers were measured via standard tensile testing methods to obtain tenacity and modulus. The mechanical properties of the round Nylon 6 fibers were compared to the extracted reentrant feature fibers with a Nylon 6 core. The reentrant feature fibers provides better mechanical properties with a tenacity of about 2.6 gpd (round 1.6 gpd) and a modulus of 9.3 gpd (round 5.8 gpd).

In one embodiment, a circular sock knitting machine was used to knit reentrant feature fibers into fabrics. Omniphobic coatings were also deposited onto fabrics made from polypropylene fibers with multiple reentrant features, 8 in one embodiment, for added protection. The reentrant features provide for an increased hydrophobic properties and the fluoro polyhedral oligomeric silsesquioxane (POSS) tecnoflon coating provide for increased hydrophobicity. A chemical additive including a cross-linker connecting polymer chains can be used as a coating so that nanoparticles provide superhydrophobic properties and oleophobic properties as well. In one embodiment, a fluoroPOSS tecnoflon hydrophobic solution was used to treat the fabric with an ˜200 nm coating. The solution was comprised of a 50/50 weight percent of fluorodecyl polyhedral oligomeric silsesquioxane (fluorodecyl POSS) and Solvay Solexis BR9151 Tecnoflon (solids concentration of 20 mg/mL). The fabric was immersed in the coating solution for 5 minutes. The fabric was taken out of the solution and left to air dry for 2 minutes. The fabric was then dried in an oven at 60° C. for 30 minutes.

This invention provides for an increased resistance to surface wetting with reentrant features that are created on the surface of the material. The reentrant features are created at the fiber level and can be trapezoidal air pockets around the perimeter of the fiber, in one embodiment. Because the more reentrant features present increase the increase the omniphobic properties, due to the increase in surface area according to the Wenzel and Cassie-Baxter models, the present invention uses can include reentrant features in excess of 6 around the perimeter of the fiber. Additionally, a coating can still be applied to the fabric surface to further enhance the omniphobicity in short term situations. The fibers can then be incorporated into woven material and garments produced which will include superomniphobic properties based on the reentrant feature geometry of the fibers.

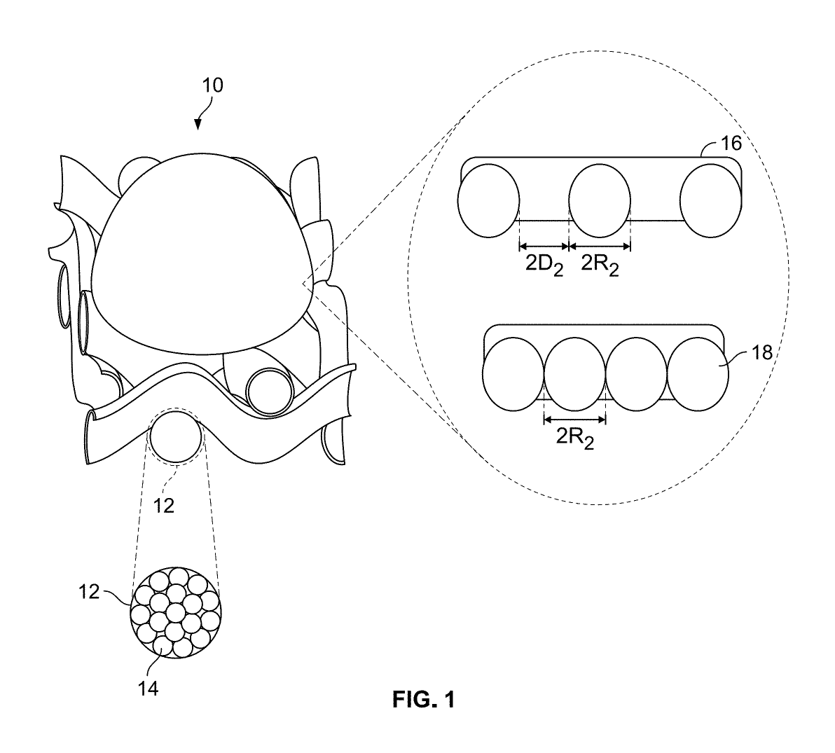

Referring to FIG. 1, the first reentrant structure or level can be shown generally at 10 as a single fiber size. The fiber can include fiber bundles 12 that include a plurality of filaments 14. The third reentrant structure can be the fabric weave structure. It can be loosely woven 16 as described by the relationship

$${D}_{2} = \frac{( {R}_{2} + {D}_{2} )}{{R}_{2}} .$$

It can be tightly woven 18 where D₂≈0.

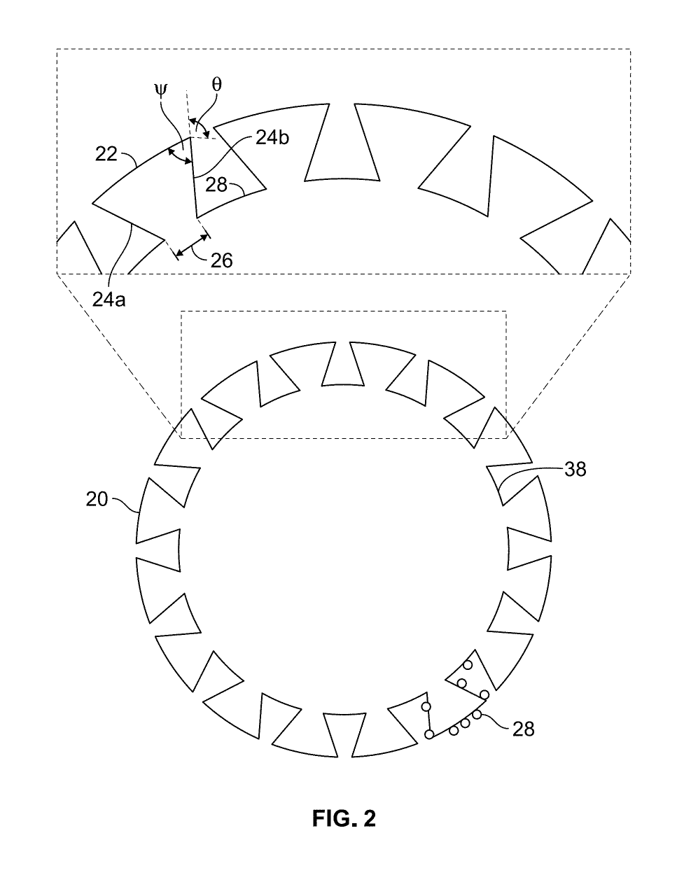

Referring to FIG. 2, the fourth reentrant feature can be a plurality of trapezoidal structures 20 that extend from the perimeter of a core 38 of a filament. Each trapezoidal structure can include a top 22, sides 24a and 24b, and a base 26. Each trapezoidal structure can include nano-sized particles 28 disposed along the top, sides, inner perimeter 30, or any combination, as a fifth reentrant feature. The trapezoidal structure includes a geometric angle ψ that optimally should be less than the equilibrium contact angle θ of the liquid contacting the filament, fiber or fabric. When ψ is greater than θ, then a liquid cannot wet the surface of the filament, fiber or fabric and therefore cannot reach the base. The fourth reentrant structure can also be a square shape one embodiment.

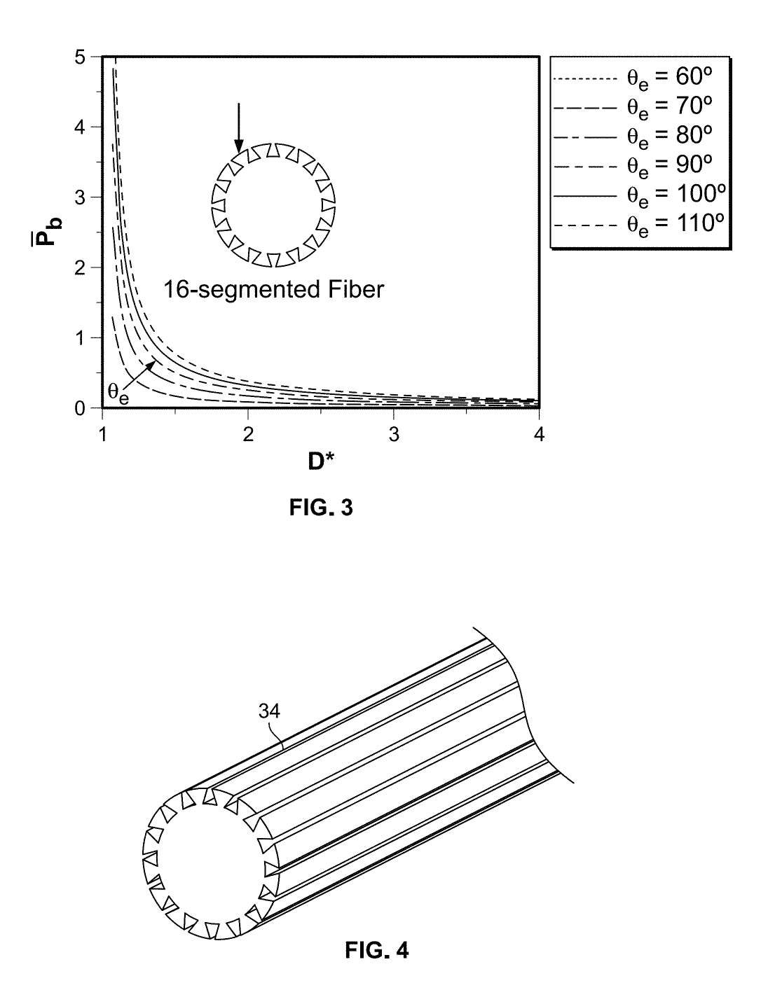

In one embodiment, the curvature of the filament can be minimized by creating a sufficient number of trapezoidal structures around the perimeter of the filament or fiber. In one embodiment the number of trapezoidal structure on the perimeter is in the range of 8 and 24. In one embodiment, there are 16 trapezoidal structures on the perimeter. As the Young's contact angle increases, the feature spacing D* decrease as shown in the chart of FIG. 3. It is advantageous, in one embodiment, to maximize ψ while minimizing D*. In one embodiment, ψ should be equal to or less than 63°.

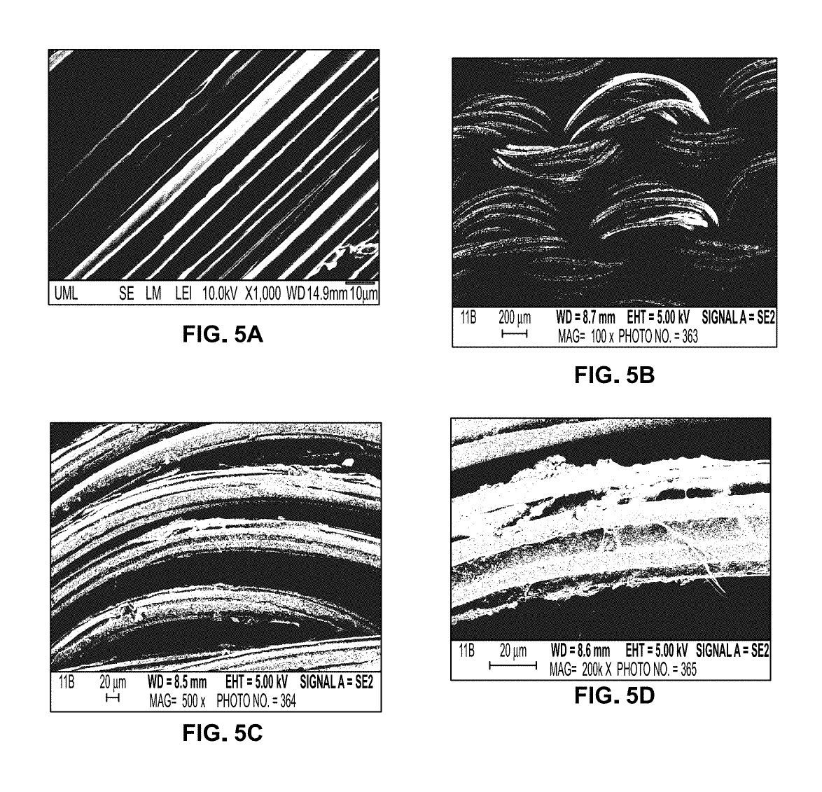

FIG. 4 shows a filament with the trapezoidal structure forming inverted channels 32 in the perimeter of the filament and along the length of the filament. A magnified illustration of a polypropylene filament with the inverted channels is shown in FIG. 5A.

Multiple knit fabrics can be produced with fabric descriptions provided in the following Table:

| | | | | Reentrant |
|---|---|---|---|---|
| Fiber Material | Ply | Extruder | Fiber Shape | Feature |
| 18 MFI | 2 | Single | Gear | 8 Features |
| Polypropylene | | Component | | |
| 1 end Nylon 6,6 | 3 | Single | Round | None |
| 2 ends 18 MFI | | Component | Gear | 8 Features |
| Polypropylene | | | | |
| 1 end Nylon 6,6 | 2 | Single | Round | None |
| 1 end 18 MFI | | Component | Gear | 8 Features |
| Polypropylene | | | | |
| 18 MFI | 2 | Bicomponent | Round | None |
| Polypropylene | | | | |
| 18 MFI | 2 | Bicomponent | Reentrant | 8 Features |
| Polypropylene | | | | |
| Nylon 6 | 2 | Bicomponent | Reentrant | 16 Features |

In one embodiment, omniphobic coatings can be applied to fabrics. A fluoroPOSS technoflon coating can be applied to one of the fabrics with nanoparticles was applied to another fabric. Polypropylene having nano-sized particles is shown at magnifications of about 100×, 500×, and 2,000× in FIGS. 5B through 5C, respectively. Contact angle measurements were performed on the knit fabric containing 18 MFI polypropylene gear shape fibers. The results from the testing are shown in the following Table with the gear shape:

| | | | Ethylene Glycol |
|---|---|---|---|
| Fabric | Treatment | Water (73 mN/m) | (48 mN/m) |
| 18 MFI | None | 116° | 104° |
| Polypropylene | | | |
| 1 end Nylon 6,6 | None | 119° | 0° |
| 2 ends 18 MFI | | | |
| Polypropylene | | | |
| 1 end Nylon 6,6 | None | 110° | 0 |
| 1 end 18 MFI | | | |
| Polypropylene | | | |

Fabrics were compared with the contact angle measured for various liquids. A fabric with round fibers and an extracted fabric with 8 reentrant feature fibers that was left untreated were included in the testing. The two extracted fabrics with 8 reentrant feature fibers treated with a fluoroPOSS tecnoflon coating with nanoparticles were also used. Water was used to test hydrophobic properties and lower surface tension liquids such as ethylene glycol, hexadecane, and octane were used to test for oleophobic properties. The contact angle measurements for each fabric are shown in the following Table:

| | | Water | Ethylene | Hexa- | Octane |
|---|---|---|---|---|---|
| | | (73 | Glycol | decane | (22 |
| Fabric | Treatment | mN/m) | (48 mN/m) | (27 mN/m) | mN/m) |
| 18 MFI PP | None | 112° | 0° | 0° | 0° |
| with 8 | | | | | |
| reentrant | | | | | |
| features | | | | | |
| 18 MFI PP | FluoroPOSS | 136° | 0° | 0° | 0° |
| with 8 | Tecnoflon | | | | |
| reentrant | | | | | |
| features | | | | | |
| 18 MFI PP | EverShield ® | 157° | 131° | 120° | 80° |
| with 8 | with | | | | |
| reentrant | nanoparticles | | | | |
| features | | | | | |

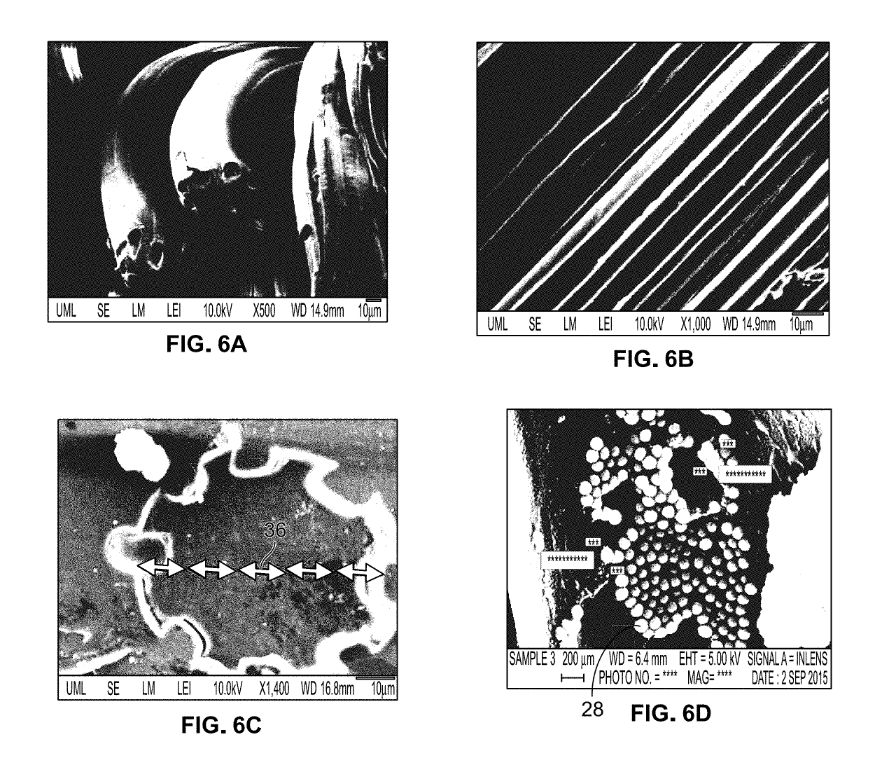

Referring to FIG. 6A, a bi-component fiber is shown magnified at about 500×. FIG. 6B shows a surface view of a reentrant fiber at about a 1,000× magnification. FIG. 6C shows a cross sectional view of a filament with 8 trapezoidal structures and a top to top diameter 36 of about 50 μm at a magnifications of about 1,400×. FIG. 6D shows a surface view of nano-particles deposited on a filament at about a 50,000× magnification. The nano-particles, in this embodiment, have a diameter of about 200 nm.

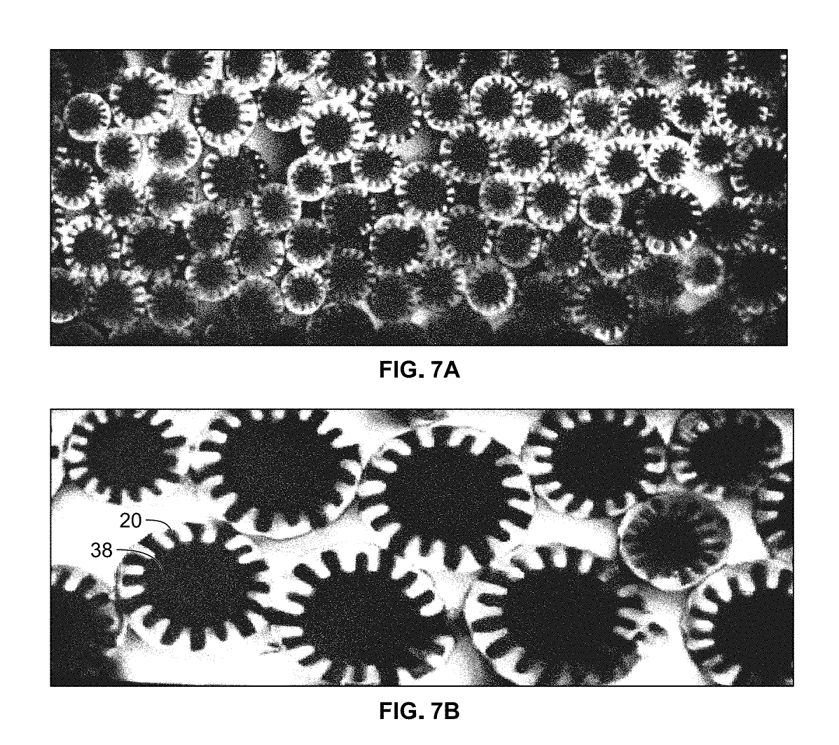

Referring to FIGS. 7A and 7B, examples of the filaments with a Nylon 6 core are shown. The extruder temperature conditions are shown in the following Table:

Extruder

| A | A | | | | | |
|---|---|---|---|---|---|---|
| Zone 1 | Zone 2 | Melt A | B Zone 1 | B Zone 2 | Melt B | Spinhead |
| (° C.) | (° C.) | (° C.) | (° C.) | (° C.) | (° C.) | (° C.) |
| 230 | 240 | 240 | 185 | 220 | 220 | 240 |

The extruder temperatures were adjusted from other materials due to the use of Nylon 6 as the core instead of a polypropylene core. The temperatures for the three temperature zones on Nylon 6 side were raised to 230° C., 240° C., and 240° C. since the melting temperature for the Nylon 6 chip is about 219° C. The overall temperature for the spinhead can also be raised to 240° C. The higher spinhead temperature did not cause the G polymer to foam since the residence time in the spinneret pack is brief. The melt spinning speed ratio between the Nylon 6 and G Polymer can be about 9.6:7.2. The resulting fibers include a large Nylon 6 core and can have shallow reentrant features. The Nylon 6 core provides increased length consistency of the reentrant features than the fibers with a polypropylene core. The Nylon 6 core fibers also can have squared off reentrant features with the G polymer sections on the outer edge of the fiber so that they can be extracted with water.

In manufacturing, 32 segmented bi-component fibers were produced, resulting in finer 16-reentrant trapezoidal structures along the fiber length. A knit fabric was woven using 16 segmented fibers. Nano-particles were added to the filament or fibers. The addition of nano-particles provides for the ability to improve the omni-phobic properties of the filament, fiber of fabric as well as to add additional physical properties including repellant properties.

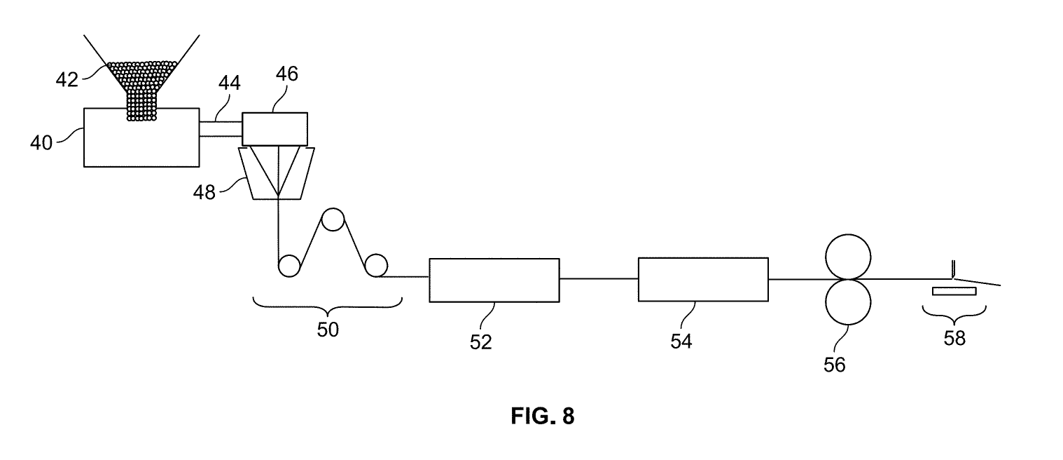

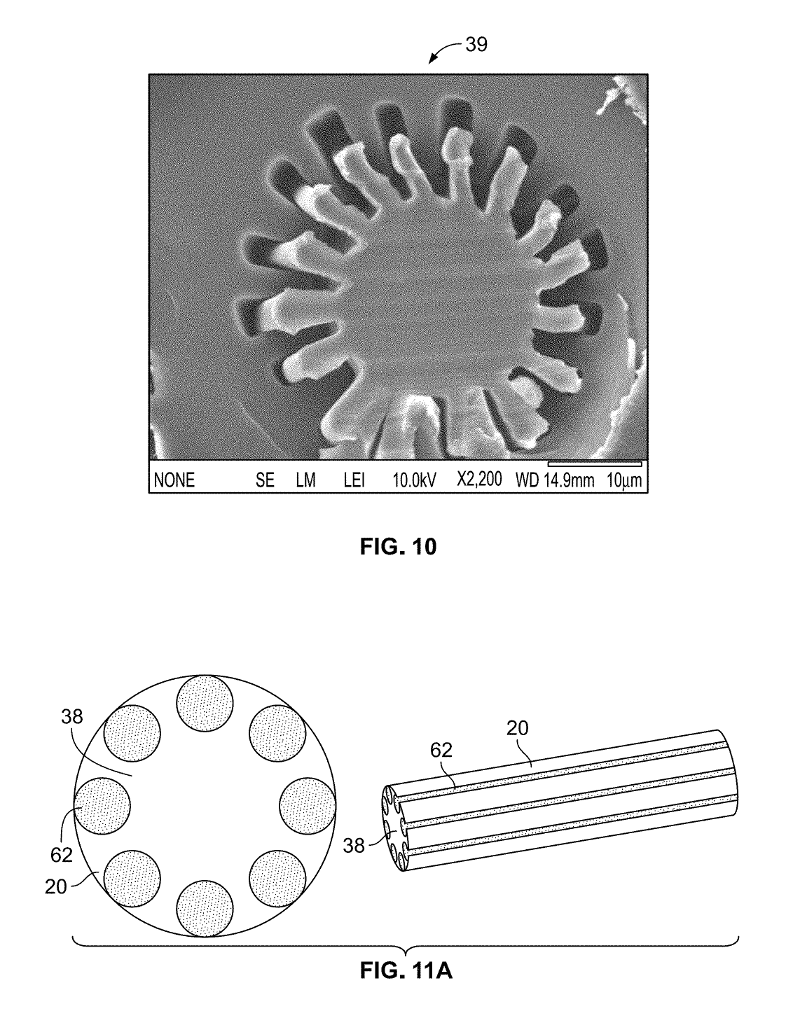

The process for creating the fiber is illustrated in FIG. 8. An extruder 40 using feedstock 42 produces filaments at 44. A spinneret can be used with multiple openings to provide multiple filaments that can be incorporated into a fiber. In one embodiment, the spinneret includes 19 openings. The filaments enter the spin pack 46 and are quenched with an air or watch quench 48 and can be drawn through drawing apparatus 50. The filaments, upon exiting the extruder or spin pack can be a co-polymer dissolved to define the trapezoidal structures. The spin pack can be specifically designed to provide for gear shapes 39 (FIG. 10). The gear shapes can include a first, second, and third core increase in size. The tooth depth can be varied from a shallow to deep. As can be seen, there can be variation from the one or more plates in the spin pack that can vary from opening size and shape, placement on the plate, and include additional geometric shapes such as slots. The composition of spin pack can include one or more of the plates in any combination. In one embodiment, the spin pack includes 9 plates.

The filaments or fiber can then pass through a heater 52 for heated drawings or stretching. The filaments or fiber can pass through a stabilizing process 54, crimper 56, and cutter 58. Tensioning and drawing can occur after the heated drawings, stabilizing process crimper or any combination. The nano-particles can be applied to the filaments, fiber or fabrics post-extrusion after the dissolvable polymer is dissolved. In one embodiment, the core is a polypropylene and the dissolvable polymer is a G polymer. The dissolvable polymer can have physical properties taken from the group consisting of extrudeable, water soluble, stretchability, high gas barrier, low foaming, emulsifiability, and biodegradable, pre-dried, or any combination thereof. The core can be a 18 MFI polypropylene.

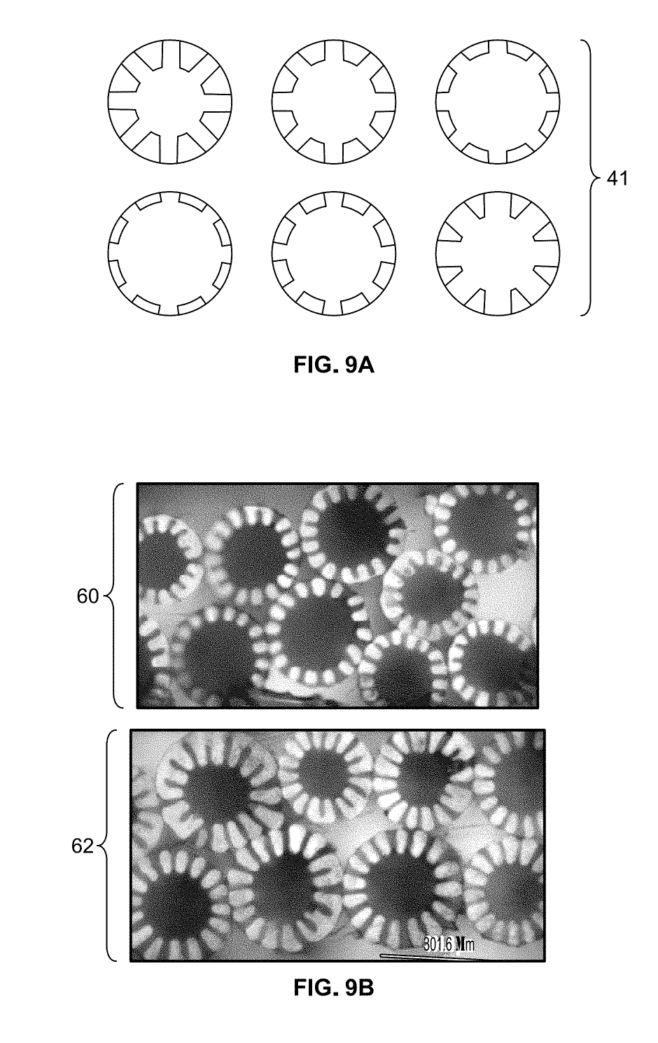

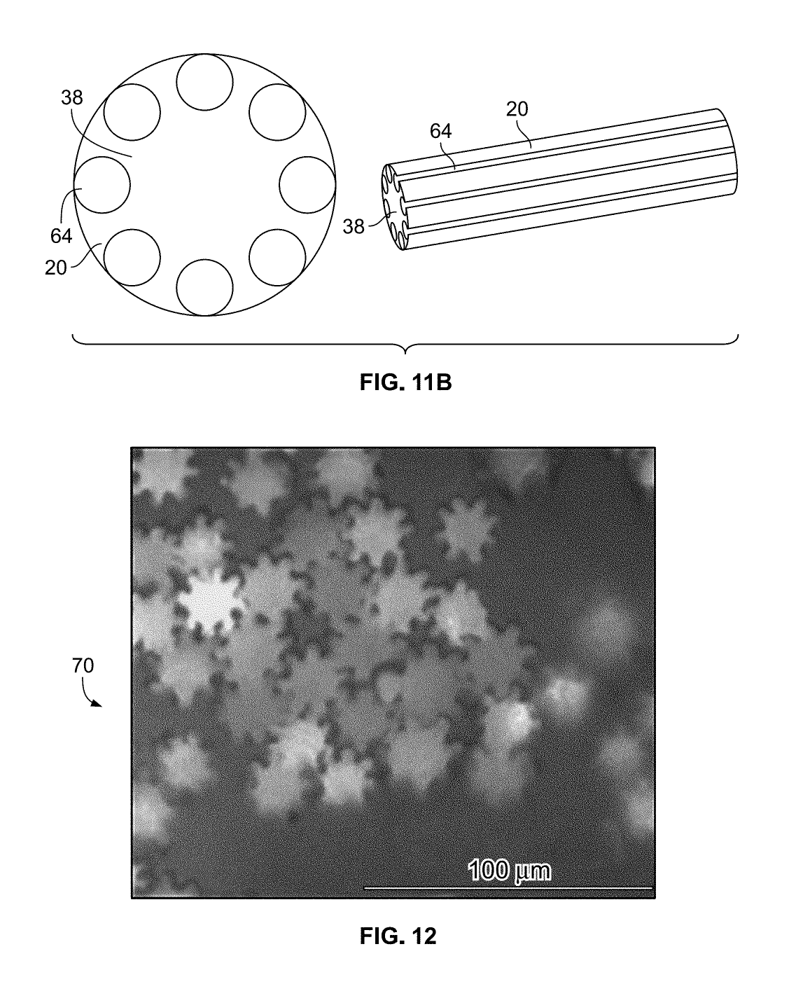

The extruder can include a plurality of zones that operate at the following temperatures in degrees C.: A Zone 1—205, A Zone 2—220, Melt A—185, B Zone 2 220, Melt B—220 and spin head—220. When extruded the co-polymer prior to dissolving the dissolvable polymer is shown as 60 (FIG. 9B) having a 2:1 melt pump speed ration. The co-polymer prior to dissolving the dissolvable polymer is shown as 62 (FIG. 11A) with a 1:1 melt pump speed ratio. In one embodiment, fibers can be directly spun using a single component melt extruder. During the melt extrusion process, a polymer chip (feedstock) can be melted down and forced through the spinneret which creates a specific shaped fiber based on the spinneret design used. The polymer chip can be dried then fed into the hopper and then the chip can enter the screw which has several heat zones to melt the chip as it is transferred to the melt pump. In one embodiment, the polymer chip is dried to lower the moisture content to reduce or prevent hydrolysis. The chips can be dried using circulating air for 35 minutes at 150° C.

The melt pump can regulates how much polymer is forced through the spinneret. After the fiber exits the spinneret, an air quench or spin finish application can be used. The spin finish controls static which helps with additional processing steps such as drawing. With bicomponent fiber melt extrusion, there can be two polymers within a single filament. The two polymers are called the sheath and the core. Each polymer can have its own hopper, screw, heating zones, melt pumps, and the two polymers come together at the spinneret. Examples of spinnerets that were used include one with round shape fibers having 50 holes and one for gear shape fibers having 30 holes. One extrusion profile for the single component fiber is shown in Table _ below:

| Extrusion | | | | | | | | | | |
|---|---|---|---|---|---|---|---|---|---|---|
| profiles for | | | | | | | | | | |
| single | | | | | | | | | | |
| component | | | | | | Melt | Spin Line | | | |
| fibers | | Extruder Temperatures ° C. | | | | Pump | | Draw Roll | Relax Roll | Filament |
| Chip | Shape | Zone 1 | Zone 2 | Zone 3 | Zone 4 | Speed (rpm) | Feed Roll (rpm) | (rpm) | (rpm) | Diameter (μm) |
| 18 MFI PP | Round | 180 | 200 | 220 | 240 | 16 | 400 | 400 | 425 | 30 |
| 18 MFI PP | Gear | 180 | 200 | 220 | 240 | 10 | 519 | 539 | 600 | 30 |

The bicomponent fibers can be spun on an extruder consists of two separate screws and melt pumps that come together to enter the same spinneret pack in order to produce a fiber with two different polymers in the same filament. There are separate temperature, pressure, and speed controls for each polymer (sheath and core). The extruder temperature conditions are shown in the following Table:

Extruder

| A | A | | | | | |
|---|---|---|---|---|---|---|
| Zone 1 | Zone 2 | Melt A | B Zone 1 | B Zone 2 | Melt B | Spinhead |
| (° C.) | (° C.) | (° C.) | (° C.) | (° C.) | (° C.) | (° C.) |
| 205 | 220 | 240 | 205 | 220 | 240 | 240 |

Spinnerets are used in order to create different cross sectional shape fibers. In one embodiment, a bicomponent fiber design includes an extractable component providing for the reentrant features in the fiber. The spinneret pack can be comprised of a top screen support plate, a plurality of cross flow plates, a plurality of distribution plates, and a spinneret plate having a plurality of holes. The top screen support plate can have two entrances, one for each polymer, that each hold a screen and seal that filter the incoming molten polymers. The distribution plates manipulate the polymer flow and can be selected based on the desired cross sectional configuration. Examples of configurations include a standard 16 segmented pie, a custom fiber with 8 reentrant features and custom fiber with 16 reentrant features. The two pack builds can be used for reentrant fibers that include multiple distribution plates. These distribution plates can be switched out to provide different combinations in order to make small adjustments to the cross sectional shape as shown at 41 FIG. 9A.

A low surface energy polymer can be used as the main component of the fiber (core 38 of FIG. 11A) and a dissolvable polymer can be used as the removable minor component (sheath 62 of FIG. 11A).

A single component extrusion process can be utilized along with a common spin pack geometry that most closely resembled the desired geometrical shape. A single component extruder can be used to spin a gear shape polypropylene fibers. In one example, a 18 MFI polypropylene chip was selected for the high extrudability and inherent hydrophobic properties of the polymer. An image of the cross sectional geometry 70 of the fibers produced are shown in FIG. 12 having 8 reentrant features.

In another embodiment, a bicomponent fibers having two polymers (sheath and core) were used to produce a single component fiber. The melt pump speeds can be adjusted to match the pressures for both polymers that can provide a segmented pie shape geometry, 16 segments in one embodiment. The fiber melt extrusion processing parameters can be varied with a 16 segmented pie shape spin pack to provide for different shape geometries. In one embodiment, the core is a 18 MFI Polypropylene, the sheath is a G Polymer and the ration of speeds between the two in the range of 12:4 and 16:4. The resulting fiber then has the G polymer removed and the remaining polypropylene core includes squared off reentrant features. In one embodiment, the results from the removal of the G polymer provide for the following physical characteristics of the resulting fiber:

| | | Weight of | Weight of | | |
|---|---|---|---|---|---|
| | Weight | Fiber | Fiber | % Mass | % Mass |
| | of Fiber | Before | After | Loss | Loss |
| Temperature | Before | Treatment | Treatment | Before | After |
| (° C.) | Drying (g) | (g) | (g) | Treatment | Treatment |
| 25 | 0.093346 | 0.087484 | 0.062126 | 6.28 | 28.99 |
| 60 | 0.094806 | 0.088652 | 0.063338 | 6.49 | 28.55 |
| 80 | 0.095456 | 0.089338 | 0.063820 | 6.41 | 28.56 |
| 100 | 0.101754 | 0.095082 | 0.067484 | 6.56 | 29.03 |

When the melt pump pressures differ the two polymers separate and the individual pieces of each polymer morph together creating a sheath/core type geometry. Multiple melt spinning variables can be altered and configured to create a fiber with the reentrant feature geometry described herein. The spinneret arrangement and geometry can be configured to provide for adjustments to the cross sectional shape of the fibers.

FIG. 10 shows a magnified view of one embodiment of the present invention.

The process includes the step of creating a bi-component filament or fiber having a core 38 and dissolvable material 62 disposed at the perimeter as shown in FIG. 11A. The dissolvable material once dissolved, results in channels 64 in the cross section as shown in FIG. 11B. The nano-particles can then be added the channels and the top of the trapezoidal structures. The nano-particles can be added by pressure impregnation, bath, deposit, coat, or any combination thereof.

Testing of the contact angle of different liquids on the fabric surfaces was performed to test the hydrophobic properties of the fabric samples. Deionized water (73 mN/m) was used test the hydrophobic properties and low surface tension liquids including ethylene glycol (48 mN/m), hexadecane (27 mN/m), and octane (22 mN/m) were used to test oleophobic properties. For each test a small piece of fabric was cut and secured to the sample platform with double sided tape.

The test liquid was placed in a syringe and a 10 μl dispense volume was selected. The droplet was magnified as it is on the suspended fabric and the image was captured. Software was used to plot where the contact angle measurement was to be measured. The contact angle results were then recorded.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits, and advantages will be apparent from the above in conjunction with the accompanying examples, data, figures, and all reasonable inferences to be drawn therefrom, alone or with consideration of the references incorporated herein.

While a preferred embodiment of the invention has been described using specific terms, such description is for illustrative purposes only, and it is to be understood that changes and variations may be made without departing from the spirit or scope of the following claims.

What is claimed is:

1. A method of extruding an omni-phobic filament comprising:
providing feedstock taken from the group consisting of a first polymer and a second polymer wherein the second polymer is dissolvable;
forcing the feedstock through a spinneret, spin pack, quench, heater, drawing apparatus, and stabilizing process;
dissolving the second polymer to create reentrant features disposed at the perimeter of the filament and along the lengths of the filament having a trapezoidal cross-section; and,
adding nano-sized particles to at least one of the top edge and the side length.

2. The method of claim 1 wherein the reentrant features include a distal angle less than 70°, a top edge greater than a side length and a bottom length less than the side length.

3. The method of claim 1 wherein the number of reentrant features is in the range of 6 to 64.

4. The method of claim 1 wherein the first polymer is taken from the group consisting of polypropylene and nylon and the second polymer is a G polymer.

5. The method of claim 1 wherein the nano-sized particles have a diameter of about 200 nm.

6. The method of claim 1 including the step of providing a fiber having a plurality of filaments and providing a fabric having an plurality of fibers.

7. The method of claim 1 wherein the reentrant features have a geometric angle less than the equilibrium contact angle of a liquid contacting the filament.

8. The method of claim 1 wherein the filament having reentrant features has a gear shaped cross section.

9. The method of claim 1 wherein the reentrant features includes a peak to peak length between adjoining reentrant section features less than 30 μm.

10. The method of claim 1 where the step of creating trapezoidal cross-section features includes creating 16 trapezoidal cross-section features.

12. A method of extruding an omni-phobic filament comprising:
extruding a co-polymer filament having a first polymer at a core and a second polymer disposed at a perimeter of the core wherein the second polymer is dissolvable;
creating reentrant features disposed at the perimeter of the core and along the lengths of the filament having a trapezoidal cross-section and having a distal angle less than 70°, a top edge greater than a side length and a bottom length less than the side length by dissolving the second polymer; and,
adding nano-sized particles to at least one of the top edge and the side length.

13. The method of claim 12 wherein the number of reentrant features is in the range of 6 to 64.

14. The method of claim 12 wherein the first polymer is taken from the group consisting of polypropylene and nylon and the second polymer is a G polymer.

15. The method of claim 12 where in the first polymer is a Nylon 6.

16. The method of claim 12 wherein the nano-sized particles have a diameter of about 200 nm.

17. The method of claim 12 including the step of providing a fiber having a plurality of filaments and providing a fabric having an plurality of fibers.

18. The method of claim 12 wherein the reentrant features have a geometric angle less than the equilibrium contact angle of a liquid contacting the filament.

19. The method of claim 12 wherein the reentrant features includes a peak to peak length between adjoining reentrant section features less than 30 μm.

20. A method of extruding an omni-phobic filament comprising:
extruding a co-polymer filament having a first polymer at a core and a second polymer disposed at a perimeter of the core wherein the second polymer is dissolvable; and,
creating a plurality of reentrant features in the range of 8 to 64 disposed at the perimeter of the core and along the lengths of the filament having a trapezoidal cross-section and having a height in the range of 5 μm to 30 μm

21. The method of claim 20 where the reentrant features includes creating a ratio of a core diameter to a trapezoidal cross-section feature height in the range of 90:10 to 60:40.

22. The method of claim 20 including adding nano-sized particles using pressure impregnation, post-extrusion bath, post-extrusion, deposit, post-extrusion coating, or any combination thereof.
